(19) United States
(12) Patent Application Publication
(10) Pub. No.: US 2021/0348532 A1
(43) Pub. Date: Nov. 11, 2021

(54) Method And Device For Checking The Functionality Of A Crankcase Ventilation System Of An Internal Combustion Engine

(71) Applicant: Vitesco Technologies GMBH, Hannover (DE)

(72) Inventors: Andreas Holzeder, Niederbayern (DE); Thomas Burkhardt, Neutraubling (DE)

(73) Assignee: Vitesco Technologies GMBH, Hannover (DE)

(21) Appl. No.: 17/379,385

(22) Filed: Jul. 19, 2021

Related U.S. Application Data
(63) Continuation of application No. PCT/EP2020/051559, filed on Jan. 23, 2020.

(30) Foreign Application Priority Data
Jan. 25, 2019 (DE) 10 2019 200 978.6

(51) Int. Cl. F01M 11/10

(52) U.S. Cl. CPC F01M 11/10; F01M 2250/00

(57) ABSTRACT

A method and a device for checking the functionality of a crankcase ventilation system of an internal combustion engine is provided. The system has a low-load vent line and a high-load vent line between a crankcase outlet of a crankcase and a respectively associated introduction point into an air path of the internal combustion engine, in which method and device the pressure prevailing in the crankcase is measured by a crankcase pressure sensor and is compared with a crankcase pressure modeled on the assumption of a fault-free crankcase ventilation system, and in which method and device information items regarding the presence of a fault and of an associated fault location in the crankcase ventilation system are determined from the comparison result.

### CROSS-REFERENCE TO RELATED APPLICATIONS

This application claims the benefit of PCT Application PCT/EP2020/051559, filed Jan. 23, 2020, which claims priority to German Application 10 2019 200 978.6, filed Jan. 25, 2019. The disclosures of the above applications are incorporated herein by reference.

### TECHNICAL FIELD

The disclosure relates to a method and device for checking the functionality of a crankcase ventilation system of an internal combustion engine.

### BACKGROUND

Due to the way an internal combustion engine operates, there are fluids in the crankcase that should not escape into the environment in order to avoid pollutant emissions. These are especially oil mist and blow-by gas consisting of combustion gas and unburnt fuel which has escaped from the cylinders, past the piston rings, into the crankcase. Since the blow-by gas flows into the crankcase from the cylinders, which are usually subject to excess pressure, then, unless there were ventilation measures, a pressure that was slightly higher than the atmosphere would build up in the crankcase during the operation of the internal combustion engine, and the gases could escape into the environment by way of any leaks that were present. To prevent this, modern internal combustion engines are equipped with one or more crankcase vent lines. At each engine operating point, these lines vent the crankcase into a region of the air intake system of the internal combustion engine in which there is currently a vacuum. As a result, the accumulating crankcase gas is drawn in by the engine and takes part in combustion in the cylinders.

In the case of spark-ignition engines, a first crankcase vent line is usually connected to the intake pipe, which is arranged downstream of the throttle valve and in which there is a greater or lesser vacuum relative to ambient pressure at low-load points, i.e. in the un-pressure-charged, normally aspirated mode of the engine. In the normally aspirated mode, excess crankcase gas can thus flow off into the intake pipe. This first crankcase vent line is referred to below as the low-load vent line.

Since, in the case of pressure-charged spark-ignition engines, there is an excess pressure in the intake pipe during the pressure-charging mode, as compared with ambient pressure, and therefore the crankcase gas cannot flow off into the intake pipe downstream of the throttle valve, a second crankcase vent line is normally connected to the air intake system downstream of the air filter in the case of pressure-charged engines. At this point, there is a slight vacuum relative to ambient pressure in the pressure-charging mode of the engine due to the pressure drop across the air filter. In the pressure-charging mode of the engine, excess crankcase gas can thus flow off into the air intake system downstream of the air filter. This second crankcase vent line is referred to below as the high-load vent line.

To avoid crankcase gas escaping into the environment after the engine is switched off, the concentration of combustion gas, fuel and oil in the crankcase should be kept as low as possible at all times by introducing air. This can be achieved by using a crankcase ventilation line to connect the crankcase to part of the air intake system in which the pressure is as high as possible, thus enabling air to flow into the crankcase.

There is the possibility that one line between the crankcase and the air intake system downstream of the air filter can perform both the function of ventilation and the function of high-load venting at different engine operating points with different pressure conditions. With the aid of check valves, a respectively unwanted flow direction of the crankcase gas can be prevented.

Due to incorrect assembly or repair of the engine and due to damage to the engine, unwanted leaks to the environment may occur. Moreover, contamination or icing of the ventilation and vent lines can lead to blockage of these lines. In this case, the crankcase gases would not be able to flow off into the intake pipe as desired but would be emitted into the environment, thereby giving rise to unwanted pollutant emissions.

To avoid the occurrence of unwanted pollutant emissions, it is possible to monitor all the lines which carry gas out of the crankcase. In this case, it should be ensured that no contaminated exhaust gases and no unburnt fuel-air mixture can escape into the environment. For this reason, detection of leaks in the crankcase ventilation system is advantageous.

A method and a system for monitoring a correct connection between a valve/separator and the inlet system through a crankcase ventilation system are known. In this system, the engine controller monitors whether a circuit formed by connecting the lines of the crankcase ventilation system is broken by unwanted opening of the lines. Breaking of the circuit is interpreted as leaking of the crankcase ventilation system.

A method and a device for diagnosing a crankcase ventilation system of internal combustion engines is also known. In this case, the crankcase is connected to an air feed system of the internal combustion engine via the ventilation device. In this method, a pressure difference between an ambient pressure and a crankcase pressure is determined, and, depending on the pressure difference determined, the presence of a fault in the ventilation device is detected if a release condition is satisfied. The release condition is satisfied if an air mass flow in the air feed system, which is filtered by a low-pass filter, exceeds a predetermined first threshold value in absolute terms.

Another known method describes detecting a leak in a crankcase ventilation system of an internal combustion engine. In this case, a cavity of a crankcase is connected for gas transmission to a fresh air tract of the internal combustion engine. Furthermore, a pressure sensor for measuring a pressure is provided in the cavity, wherein an electronic control unit is provided for signal evaluation of the sensor. A gas pressure is measured by the pressure sensor in the crankcase ventilation system at a defined speed and load of the internal combustion engine. A comparison between an actual pressure value and a setpoint pressure value is furthermore carried out. If the actual pressure value exceeds the setpoint pressure value, the presence of a leak is detected.

### SUMMARY

The disclosure specifies a method and a device for checking the functionality of a crankcase ventilation system of an internal combustion engine in which faults in the crankcase ventilation system may be detected and traced with a high degree of reliability.

One aspect of the disclosure provides a method for checking the functionality of a crankcase ventilation system of an internal combustion engine. The internal combustion system includes a low-load vent line and a high-load vent line between a crankcase outlet of a crankcase and a respectively associated introduction point into an air path of the internal combustion engine, is checked by measuring the pressure prevailing in the crankcase by a crankcase pressure sensor and comparing it with a crankcase pressure modeled on the assumption of a fault-free crankcase ventilation system, and determining information items regarding the presence of a fault and an associated fault location in the crankcase ventilation system from the comparison result.

Implementations of the disclosure may include one or more of the following optional features. In some implementations, the advantages of the disclosure include, for example, that specific faults which occur in the crankcase ventilation system may be detected and traced. Detection and location of the faults which occur in the crankcase ventilation system is accomplished by performing and evaluating a comparison of crankcase pressure signals measured by a crankcase sensor and crankcase pressure signals modeled on the assumption of a fault-free crankcase ventilation system. For this fault detection and fault location, it is not necessary to have recourse to the output signals of further sensors, for example the output signals of intake pipe pressure sensors and lambda sensors.

In some implementations, the information items on the fault location in the crankcase ventilation system are determined from a comparison of the time characteristic of the measured crankcase pressure with the time characteristic of the modeled crankcase pressure.

In some examples, the information items on the fault location in the crankcase ventilation system are determined after a change in the engine operating point from a comparison of the time characteristic of the measured crankcase pressure with the time characteristic of the modeled crankcase pressure.

In some implementations, the change in the engine operating point is detected. For example, an engine operating point is described by a combination of engine speed and intake pipe pressure. A rapid change in the engine speed and/or intake pipe pressure counts as a change in the operating point.

The pressure measurement may be performed by a crankcase pressure sensor arranged in the crankcase.

In some examples, the pressure measurement is performed by a pressure sensor which is arranged in a line connected directly to the crankcase.

A change from a low-load operating point, i.e. an engine operating point with a low intake pipe pressure, to a high-load operating point, i.e. an engine operating point with a high intake pipe pressure, may be used for diagnosis.

In some examples, the speed of the rise in the measured crankcase pressure is compared in a diagnostic time window with the speed of the rise in the modeled crankcase pressure, and, if the measured crankcase pressure rises more quickly to the ambient pressure than the modeled crankcase pressure, the presence of a leak in a crankcase ventilation line or the high-load vent line is detected.

The system may check whether the measured crankcase pressure exceeds the modeled crankcase pressure and the ambient pressure at the end of a diagnostic time window and, in the case where the measured crankcase pressure exceeds the modeled crankcase pressure and the ambient pressure, the presence of a defect of a check valve arranged in the low-load vent line is detected.

In some implementations, the speed of the rise in the measured crankcase pressure is compared in a diagnostic time window with the speed of the rise in the modeled crankcase pressure, and, if the measured crankcase pressure rises more slowly than the modeled crankcase pressure, the presence of a blockage of the crankcase ventilation line is detected.

In some examples, a change from a high-load operating point to a low-load operating point is used for diagnosis.

The speed of the fall in the measured crankcase pressure is compared in a diagnostic time window with the speed of the fall in the modeled crankcase pressure, and, if the measured crankcase pressure falls more slowly than the modeled crankcase pressure, a blockage of the low-load vent line or a defective pressure control valve is detected.

In some implementations, the disclosure relates to a device for checking the functionality of a crankcase ventilation system of an internal combustion engine, which system has a low-load vent line and a high-load vent line between a crankcase outlet of a crankcase and a respectively associated introduction point into an air path of the internal combustion engine, in which device a control unit is provided which is designed to carry out the method according to the disclosure.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic diagram intended to illustrate a device for checking the functionality of a crankcase ventilation system of an internal combustion engine,

FIG. 2 shows a diagram in which fault locations are marked,

FIG. 3 shows diagrams intended to illustrate measurement results,

FIG. 4 shows a diagram in which a fault location is marked,

FIG. 5 shows diagrams intended to illustrate measurement results,

FIG. 6 shows a diagram in which fault locations are marked,

FIG. 7 shows diagrams intended to illustrate measurement results,

FIG. 8 shows a diagram in which fault locations are marked, and

FIG. 9 shows diagrams intended to illustrate measurement results.

Like reference symbols in the various drawings indicate like elements.

### DETAILED DESCRIPTION

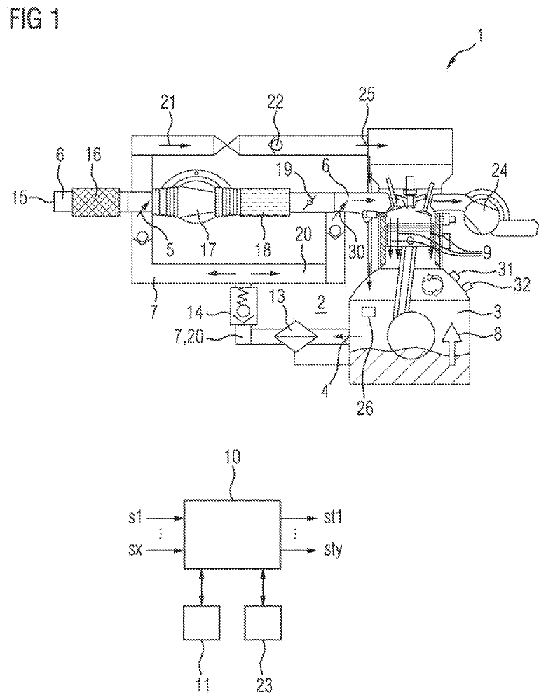

FIG. 1 shows a schematic diagram intended to illustrate a device for checking the functionality of a crankcase ventilation system 2 of an internal combustion engine 1.

The illustrated internal combustion engine 1 includes a crankcase 3, from which gases are discharged via a crankcase outlet 4 and introduced via crankcase vent lines 7 and 20 into an air path 6 of the internal combustion engine 1 at introduction points 5 and 30, respectively. These gases are blow-by gas 9 and hydrocarbon vapors from the oil, these vapors being denoted in FIG. 1 by the reference numeral 8. Crankcase vent line 7 is a high-load vent line. Crankcase vent line 20 is a low-load vent line.

As shown, an oil separator 13 and a pressure control valve 14 are arranged in these crankcase vent lines 7, 20, between the crankcase outlet 4 and the introduction points 5 and 30, respectively. Downstream of the pressure control valve 14, the high-load vent line 7 separates from the low-load vent line 20. The high-load vent line 7 opens into the air path 6 at introduction point 5 upstream of a compressor 17. The low-load vent line 20 opens into the air path 6 downstream of a throttle valve 19 at introduction point 30.

In the normally aspirated mode of the internal combustion engine 1, the throttle valve 19 is partially closed, and the gas pressure within the air path 6 downstream of the throttle valve 19 is lower than the ambient air pressure. Consequently, gas discharged from the crankcase 3 is introduced into the air path 6 via the oil separator 13, the pressure control valve 14 and the low-load vent line 20 downstream of the throttle valve 19.

In the pressure-charged mode of the internal combustion engine 1, the throttle valve 19 is open, and therefore fresh air is fed to the air path 6 via the fresh air inlet 15, and is fed to the combustion chamber of the internal combustion engine 1 via an air filter 16, the compressor 17, a charge air cooler 18 and the opened throttle valve 19. In this pressure-charged mode of the internal combustion engine 1, the air pressure in the air path 6 in the region downstream of the throttle valve 19 is greater than the ambient air pressure. Consequently, gas discharged from the crankcase 3 is introduced into the air path 6 via the oil separator 13 and the pressure control valve 14 not downstream of the throttle valve 19 but via the high-load vent line 7, at introduction point 5. This introduction point 5 is positioned in the air path 6 downstream of the air filter 16 but upstream of the compressor 17, of the charge air cooler 18 and of the throttle valve 19.

The device illustrated in FIG. 1 furthermore has a crankcase pressure sensor 26, which is arranged in the crankcase 3 and by which the pressure prevailing in the crankcase 3 is measured. As an alternative, this crankcase pressure sensor 26 can also be arranged in a line directly connected to the crankcase 3, e.g. between the crankcase and the oil separator 13 or between the check valve 22 and a ventilation inlet 25 of the crankcase. The output signals provided by the crankcase pressure sensor 26 are fed as sensor signals s1 to a control unit 10 and evaluated therein in order to perform checking of the functionality of the crankcase ventilation system 2 of the internal combustion engine 1, as explained in greater detail below.

It can furthermore be seen from FIG. 1 that the device illustrated has a fresh air line 21 which branches off from the air path 6 and which is connected via a check valve 22 to the ventilation inlet 25 of the crankcase 3. This air is used to improve the outflow of the crankcase gases through the crankcase 3 during engine operation.

FIG. 1 furthermore illustrates a turbine 24, which, together with the compressor 17, is a component part of an exhaust turbocharger. This turbine 24 is fed with hot exhaust gas from the internal combustion engine and imparts rotation to the turbine wheel of the turbine. The turbine wheel is connected via a shaft of the exhaust turbocharger to a compressor impeller of the compressor 17, which is likewise firmly connected to the shaft, and therefore a rotary motion is also imparted to the compressor impeller, which compresses the fresh air fed to the compressor 17. This compressed fresh air is fed to the combustion chambers of the internal combustion engine 1 to boost the power thereof.

The oil separator 13 separates out oil contained in the gases discharged via the crankcase outlet 4 and feeds it back into the crankcase 3.

Furthermore, the device illustrated in FIG. 1 has an oil cap 31, which closes the crankcase, and an oil dipstick 32.

Moreover, FIG. 1 illustrates that the control unit 10 interacts with memories 11 and 23. Memory 11 is a memory in which the work programs of the control unit are stored. Memory 23 is a data memory that stores data. The stored data is needed by the control unit 10 inter alia for checking the functionality of the crankcase ventilation system. These include empirically determined data stored in one or more characteristic maps. For example, these data include data which correspond to a pressure model needed for carrying out the method according to the disclosure. Stored in this pressure model are data which correspond to a crankcase pressure modeled on the assumption of a fault-free crankcase ventilation system 2.

The control unit 10 evaluates the crankcase pressure sensor signals s1 fed to it using the pressure model data stored in the memory 23 in order to check the functionality of the crankcase ventilation system 2 and to ascertain whether the crankcase ventilation system is functional or not and, where applicable, to identify the respective fault location.

Accordingly, the device illustrated in FIG. 1 shows a crankcase ventilation system of a pressure-charged internal combustion engine in which a high-load vent line and a low-load vent line lead from the crankcase outlet into the air path, via which lines gases are carried out of the crankcase into the air path. Here, the low-load vent line 20 is connected to the air path 6 downstream of a throttle valve 19 controlling the air mass flow and is active during the partially throttled mode, in which the pressure prevailing between the throttle valve 19 and the inlet of the crankcase 3 is lower than the ambient pressure, and carries gas discharged from the crankcase 3, via introduction point 30, into the air path 6. In the pressure-charged mode, the high-load vent line 7, in which the pressure prevailing between the throttle valve 19 and the inlet of the crankcase 3 is higher than the ambient pressure, is active and carries gas discharged from the crankcase 3, via introduction point 5, into the air path 6.

In some examples, when changes in the operating point occur, pressure values are measured for the pressure prevailing in the crankcase and compared with pressure model data stored in memory 23, where the data stored in the pressure model are data determined on the assumption of the presence of a fault-free crankcase ventilation system, are described below with reference to the further FIG.s.

In this context, examples of checks on the functionality of the crankcase ventilation system 2 of the internal combustion engine 1 illustrated in FIG. 1 are explained in greater detail with reference to the further figures.

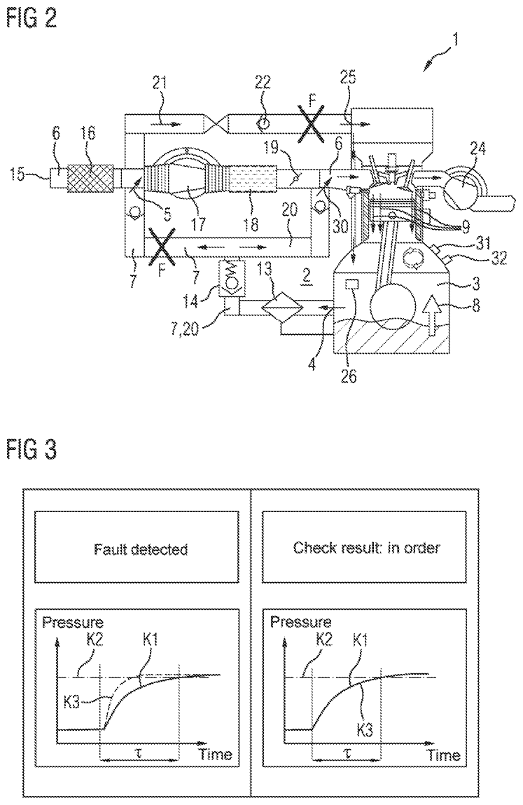

FIG. 2 shows the internal combustion engine 1 illustrated in FIG. 1 when a leak is present in the ventilation line 21 or the high-load vent line 7 with respect to the ambient pressure. These fault locations are each denoted by the letter F in FIG. 2.

These leaks are detected by the control unit 10 if the crankcase pressure measured by the crankcase pressure sensor 26 rises more quickly to ambient pressure when there is a change from a low-load operating point to a high-load operating point than is stored for a fault-free system in the stored pressure module.

FIG. 3 shows diagrams which illustrate the associated measurement results. In these diagrams, the signal characteristic denoted by K1 indicates the modeled crankcase pressure, the signal characteristic denoted by K2 indicates the ambient pressure, and the signal characteristic denoted by K3 indicates the crankcase pressure measured by the crankcase pressure sensor 26.

The left-hand diagram in FIG. 3 illustrates that by comparing the characteristic K1 of the modeled crankcase pressure with the characteristic K3 of the measured crankcase pressure after a change from a low-load operating point to a high-load operating point, in a diagnostic time window τ, it is possible to detect that the rise in the measured crankcase pressure to ambient pressure takes place more quickly than the rise in the modeled crankcase pressure to ambient pressure. In this case, the control unit 10 recognizes that there is a leak in the crankcase ventilation line 21 or the high-load vent line 7, as indicated in FIG. 2 by the letter F.

In the right-hand diagram in FIG. 3, the fault-free state of the crankcase ventilation system is illustrated. In this fault-free state, the characteristic K1 of the modeled crankcase pressure coincides with the characteristic K3 of the measured crankcase pressure within the diagnostic time window τ. The modeled crankcase pressure and the measured crankcase pressure rise to the ambient pressure within the same time.

The diagnostic time window τ is opened by the control unit 10 when there is a change in the operating point from a low-load operating point to a high-load operating point and is ended after the expiry of a predetermined time period.

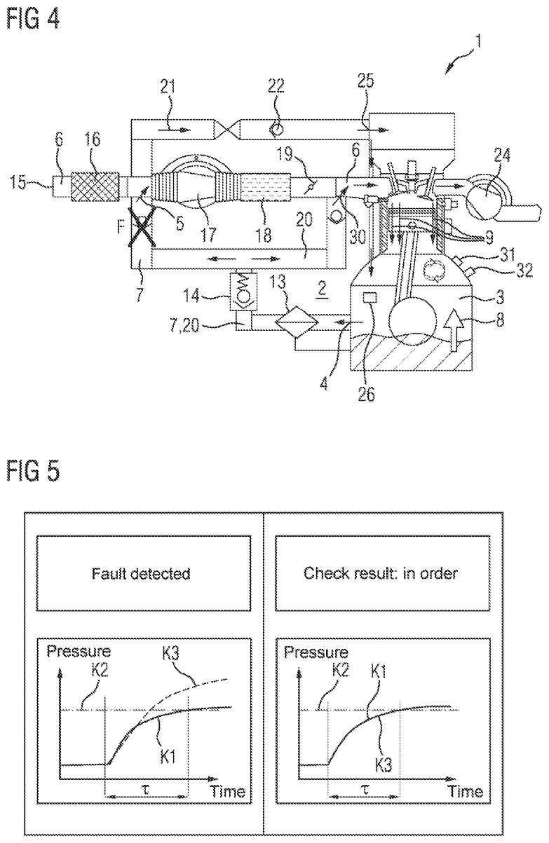

FIG. 4 shows the internal combustion engine 1 illustrated in FIG. 1 when there is a defect of a check valve arranged in the high-load vent line 7. This fault location is denoted by the letter F in FIG. 4.

This defect of the check valve in the high-load vent line 7 is detected by the control unit 10 if the crankcase pressure measured by the crankcase pressure sensor 26 rises more quickly and more strongly above ambient pressure within a diagnostic time window τ than is stored for the fault-free system.

FIG. 5 shows diagrams which illustrate the associated measurement results. In these diagrams, the signal characteristic denoted by K1 indicates the modeled crankcase pressure, the signal characteristic denoted by K2 indicates the ambient pressure, and the signal characteristic denoted by K3 indicates the crankcase pressure measured by the crankcase pressure sensor 26.

The left-hand diagram in FIG. 5 illustrates that by comparing the characteristic K1 of the modeled crankcase pressure with the characteristic K3 of the measured crankcase pressure after a change from a low-load operating point to a high-load operating point, in a diagnostic time window τ, it is possible to detect that the rise in the measured crankcase pressure to a pressure above ambient pressure takes place more quickly and more strongly than the rise in the modeled crankcase pressure to ambient pressure. In this case, the control unit 10 recognizes that there is a defect of the check valve arranged in the high-load vent line 7, as indicated in FIG. 4 by the letter F.

In the right-hand diagram in FIG. 5, the fault-free state of the crankcase ventilation system is illustrated. In this fault-free state, the characteristic K1 of the modeled crankcase pressure coincides with the characteristic K3 of the measured crankcase pressure within the diagnostic time window τ. The modeled crankcase pressure and the measured crankcase pressure rise to the ambient pressure within the same time.

The diagnostic time window τ is opened by the control unit 10 when there is a change in the operating point from a low-load operating point to a high-load operating point, and is ended after the expiry of a predetermined time period.

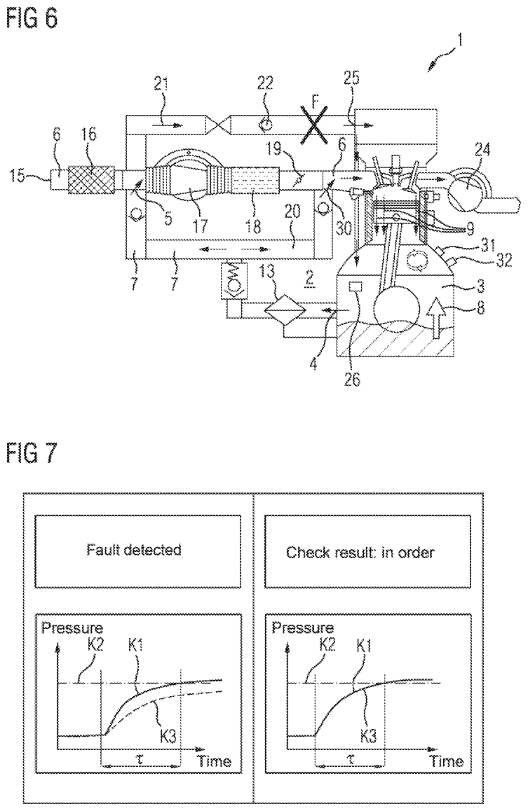

FIG. 6 shows the internal combustion engine 1 illustrated in FIG. 1 when there is a blockage of the crankcase ventilation line 21. This fault location is denoted by the letter F in FIG. 6.

This blockage of the crankcase ventilation line 21 is detected by the control unit 10 if the crankcase pressure measured by the crankcase pressure sensor 26 rises more slowly within a diagnostic time window τ after a change from a low-load operating point to a high-load operating point than is stored for the fault-free system.

FIG. 7 shows diagrams which illustrate the associated measurement results. In these diagrams, the signal characteristic denoted by K1 indicates the modeled crankcase pressure, the signal characteristic denoted by K2 indicates the ambient pressure, and the signal characteristic denoted by K3 indicates the crankcase pressure measured by the crankcase pressure sensor.

The left-hand diagram in FIG. 7 illustrates that by comparing the characteristic K1 of the modeled crankcase pressure with the characteristic K3 of the measured crankcase pressure after a change from a low-load operating point to a high-load operating point, in a diagnostic time window τ, it is possible to detect that the rise in the measured crankcase pressure within the diagnostic time window τ takes place more slowly than the rise in the modeled crankcase pressure to ambient pressure. In this case, the control unit 10 recognizes that there is a blockage of the crankcase ventilation line 21, as indicated in FIG. 6 by the letter F.

In the right-hand diagram in FIG. 7, the fault-free state of the crankcase ventilation system is illustrated. In this fault-free state, the characteristic K1 of the modeled crankcase pressure coincides with the characteristic K3 of the measured crankcase pressure within the diagnostic time window τ. The modeled crankcase pressure and the measured crankcase pressure rise to the ambient pressure within the same time.

The diagnostic time window τ is opened by the control unit 10 when there is a change in the operating point from a low-load operating point to a high-load operating point, and is ended after the expiry of a predetermined time period.

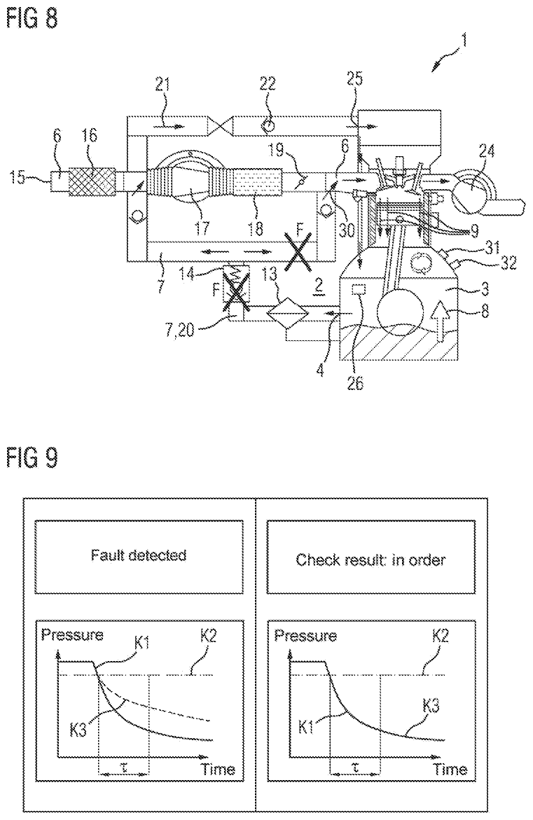

FIG. 8 shows the internal combustion engine 1 illustrated in FIG. 1 when there is a blockage of the low-load vent line 20 or a defect of the pressure control valve 14. These fault locations are denoted by the letter F in FIG. 8.

These faults are detected by the control unit 10 if the crankcase pressure measured of the crankcase pressure sensor 26 falls more slowly within a diagnostic time window τ after a change from a high-load operating point to a low-load operating point than is stored for the fault-free system.

FIG. 9 shows diagrams which illustrate the associated measurement results. In these diagrams, the signal characteristic denoted by K1 indicates the modeled crankcase pressure, the signal characteristic denoted by K2 indicates the ambient pressure, and the signal characteristic denoted by K3 indicates the crankcase pressure measured by the crankcase pressure sensor.

The left-hand diagram in FIG. 9 illustrates that by comparing the characteristic K1 of the modeled crankcase pressure with the characteristic of K3 of the measured crankcase pressure after a change from a high-load operating point to a low-load operating point, in a diagnostic time window τ, it is possible to detect that the fall in the measured crankcase pressure within the diagnostic time window τ takes place more slowly than the fall in the modeled crankcase pressure. In this case, the control unit 10 recognizes that there is a blockage of the low-load vent line 20 or a defective pressure control valve 14, as indicated in FIG. 8 by the letter F.

In the right-hand diagram in FIG. 9, the fault-free state of the crankcase ventilation system is illustrated. In this fault-free state, the characteristic K1 of the modeled crankcase pressure coincides with the characteristic K3 of the measured crankcase pressure within the diagnostic time window τ. The falls in the modeled crankcase pressure and the measured crankcase pressure coincide.

The diagnostic time window τ is opened by the control unit 10 when there is a change in the operating point from a high-load operating point to a low-load operating point, and is ended after the expiry of a predetermined time period.

When there is a quick change in the engine operating point from a high-load operating point with an intake pipe pressure close to ambient pressure or significantly above ambient pressure to a low-load operating point with an intake pipe pressure of less than the desired crankcase pressure of, for example, 100 hPa below ambient pressure, there is a transition in the crankcase from the second state with a high crankcase pressure of, for example, 30 hPa below ambient pressure to the first state with a low crankcase pressure of, for example, 100 hPa below ambient pressure. At the time of a quick change in the operating point, the intake pipe pressure falls below the crankcase pressure, and the crankcase venting mass flow via the low-load vent line 20 begins to flow again. From this time onward, the crankcase pressure falls quickly to the desired crankcase pressure of, for example, 100 hPa below ambient pressure and stabilizes there in the case of a fault-free system owing to the pressure equalization via the low-load vent line.

The time characteristic of the pressure drop in the crankcase in the fault-free system after a change in the engine operating point from a high-load operating point to a low-load operating point is stored in the pressure model mentioned. From a comparison of the stored pressure model values with measured pressure values, it is possible to detect whether or not there is a defect of the crankcase ventilation system.

A number of implementations have been described. Nevertheless, it will be understood that various modifications may be made without departing from the spirit and scope of the disclosure. Accordingly, other implementations are within the scope of the following claims.

### LIST OF REFERENCE SIGNS

1 Internal combustion engine
2 Crankcase ventilation system
3 Crankcase
4 Crankcase outlet
5 Introduction point
6 Air path
7 High-load vent line
8 Evaporation
9 Blow-by gases
10 Control unit
11 Memory
13 Oil separator
14 Pressure control valve
15 Fresh air inlet
16 Air filter
17 Compressor
18 Charge air cooler
19 Throttle valve
20 Low-load vent line
21 Crankcase ventilation line
22 Check valve
23 Memory
24 Turbine
25 Ventilation inlet of the crankcase
26 Crankcase pressure sensor
30 Introduction point
31 Oil cap
32 Oil dipstick

What is claimed is:

1. A method for checking the functionality of a crankcase ventilation system of an internal combustion engine, the crankcase ventilation system includes a low-load vent line and a high-load vent line between a crankcase outlet of a crankcase and a respectively associated introduction point into an air path of the internal combustion engine, the method comprising:
measuring pressure prevailing in the crankcase by a crankcase pressure sensor;
determining a comparison result by comparing the measured pressure with a crankcase pressure modeled on an assumption of a fault-free crankcase ventilation system; and
determining information items regarding a presence of a fault and an associated fault location in the crankcase ventilation system based on the comparison result.

2. The method as claimed in claim 1, wherein comparing the measured pressure with the crankcase pressure includes comparing a time characteristic of the measured crankcase pressure with a time characteristic of the modeled crankcase pressure.

3. The method as claimed in claim 2, wherein the information items on the fault location in the crankcase ventilation system are determined after a change in the engine operating point from a comparison of the time characteristic of the measured crankcase pressure with the time characteristic of the modeled crankcase pressure.

4. The method as claimed in claim 3, wherein the change in the engine operating point is detected when an engine speed and/or an intake pipe pressure changes more quickly than a predetermined threshold value.

5. The method as claimed in claim 1, wherein the crankcase pressure sensor is arranged in the crankcase.

6. The method as claimed in claim 1, wherein the pressure sensor is arranged in a line connected directly to the crankcase.

7. The method as claimed in claim 3, wherein a change from a low-load operating point to a high-load operating point is detected.

8. The method as claimed in claim 7, wherein a speed of a rise in the measured crankcase pressure is compared in a diagnostic time window with a speed of a rise in the modeled crankcase pressure, and, if the measured crankcase pressure rises more quickly to an ambient pressure than the modeled crankcase pressure, the presence of a leak in a crankcase ventilation line or the high-load vent line is detected.

9. The method as claimed in claim 7, in which the system checks whether the measured crankcase pressure exceeds the modeled crankcase pressure and an ambient pressure at an end of a diagnostic time window and, in when the measured crankcase pressure exceeds the modeled crankcase pressure and the ambient pressure, the presence of a defect of a check valve arranged in the high-load vent line is detected.

10. The method as claimed in claim 7, in which a speed of a rise in the measured crankcase pressure is compared in a diagnostic time window with the speed of a rise in the modeled crankcase pressure, and, if the measured crankcase pressure rises more slowly than the modeled crankcase pressure, the presence of a blockage of the crankcase ventilation line is detected.

11. The method as claimed in claim 3, in which a change from a high-load operating point to a low-load operating point is detected.

12. The method as claimed in claim 11, in which a speed of a fall in the measured crankcase pressure is compared in a diagnostic time window with a speed of a fall in the modeled crankcase pressure, and, if the measured crankcase pressure falls more slowly than the modeled crankcase pressure, a blockage of the low-load vent line or a defective pressure control valve is detected.

13. A device for checking the functionality of a crankcase ventilation system of an internal combustion engine, the crankcase ventilation system includes a low-load vent line and a high-load vent line between a crankcase outlet of a crankcase and a respectively associated introduction point into an air path of the internal combustion engine, the device comprising:
a control unit configured to:
measure pressure prevailing in the crankcase by a crankcase pressure sensor;
determine a comparison result by comparing the measured pressure with a crankcase pressure modeled on an assumption of a fault-free crankcase ventilation system; and
determining information items regarding a presence of a fault and an associated fault location in the crankcase ventilation system based on the comparison result.

14. The device as claimed in claim 13, wherein comparing the measured pressure with the crankcase pressure includes comparing a time characteristic of the measured crankcase pressure with a time characteristic of the modeled crankcase pressure.

15. The device as claimed in claim 14, wherein the information items on the fault location in the crankcase ventilation system are determined after a change in the engine operating point from a comparison of the time characteristic of the measured crankcase pressure with the time characteristic of the modeled crankcase pressure.

16. The device as claimed in claim 15, wherein the change in the engine operating point is detected when an engine speed and/or an intake pipe pressure changes more quickly than a predetermined threshold value.

17. The device as claimed in claim 13, wherein the crankcase pressure sensor is arranged in the crankcase.

18. The device as claimed in claim 13, wherein a speed of a rise in the measured crankcase pressure is compared in a diagnostic time window with a speed of a rise in the modeled crankcase pressure, and, if the measured crankcase pressure rises more quickly to an ambient pressure than the modeled crankcase pressure, the presence of a leak in a crankcase ventilation line or the high-load vent line is detected.

19. The device as claimed in claim 13, in which the system checks whether the measured crankcase pressure exceeds the modeled crankcase pressure and an ambient pressure at an end of a diagnostic time window and, when the measured crankcase pressure exceeds the modeled crankcase pressure and an ambient pressure, the presence of a defect of a check valve arranged in the high-load vent line is detected.

20. The device as claimed in claim 13, in which a speed of a rise in the measured crankcase pressure is compared in a diagnostic time window with a speed of a rise in the modeled crankcase pressure, and, if the measured crankcase pressure rises more slowly than the modeled crankcase pressure, the presence of a blockage of the crankcase ventilation line is detected.
